(19) United States
(12) Patent Application Publication
(10) Pub. No.: US 2012/0056844 A1
(43) Pub. Date: Mar. 8, 2012

(54) CAPACITIVE TOUCH SCREEN

(75) Inventors: Woon Chun Kim, Gyunggi-do (KR); Yong Soo Oh, Gyunggi-do (KR); Jae Il Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/978,784

(22) Filed: Dec. 27, 2010

(30) Foreign Application Priority Data
Sep. 8, 2010 (KR) 1020100088008

(51) Int. Cl. G06F 3/045

(52) U.S. Cl. 345/174

(57) ABSTRACT

Disclosed herein is a capacitive touch screen. The capacitive touch screen includes: a base member including an active region through which an image generated in a display passes and an inactive region which extends from the active region and is formed to be stepwise; a plurality of electrode patterns which intersects with the top and the bottom of the base member and are disposed in the active region; electrode wirings which are connected to the electrode patterns disposed in the active region and extend to the inactive region; and a window formed on the top of the base member.

### CROSS REFERENCE TO RELATED APPLICATION

This application claims the benefit of Korean Patent Application No. 10-2010-0088008, filed on Sep. 8, 2010, entitled “Capacitive Touch Screen”, which is hereby incorporated by reference in its entirety into this application.

### BACKGROUND OF THE INVENTION

1. Technical Field

The present invention relates to a capacitive touch screen.

2. Description of the Prior art

In general, with development of a mobile communication technology, terminals such as a cellular phone, a PDA, and a navigation are extending their functions as more various and complicated multimedia providing means such as an audio, a moving picture, a wireless Internet web browser, etc., in addition to a simple text information display means. In recent years, as the implementation of larger display screens are required within a limited size of a terminal, a display type adopting a touch screen has been in the limelight. The touch screen integrates a screen and a coordinate input unit to save space in comparison with a key input scheme in the prior art.

The type of the touch screen which is widely adopted is generally classified into two types.

First, in a resistive touch screen, an upper substrate with an upper resistive film and a lower substrate with a lower resistive film are spaced apart from each other by a spacer and may contact each other by external force. When the upper substrate with the upper electrode film is pressed by input unit such as a finger, a pen, or the like, the upper and lower electrode films are electrically conducted to each other and voltage variation depending on the variation of a resistance value at the position thereof is detected by a controller to detect a touch coordinate.

In addition, in a capacitive touch screen, an upper substrate with a first electrode pattern having a first directionality and a lower substrate with a second electrode pattern having a second directionality are spaced apart from each other and an insulator is inserted therebetween to prevent the first electrode pattern and the second electrode pattern from contacting each other. Further, electrode wirings connected to the electrode patterns are formed on the upper substrate and the lower substrate. The electrode wirings transfers the change in capacitances generated in the first electrode pattern and the second electrode pattern to a controller as the input unit touches the touch screen.

In recent years, research into the capacitive touch screen has been in progress toward the rise of the effectiveness of multi-touches and the increase in the number of electrode patterns. As a result, the number of electrode wirings also increases.

In the capacitive touch screen in the prior art, the electrode pattern and the electrode wiring are separately formed for each of the upper substrate and the lower substrate, such that the structure of the touch screen is complicated. In addition, an additional insulator is required to space the electrode patterns formed on the upper substrate and the lower substrate apart.

Moreover, the electrode patterns and the electrode wirings are formed on the upper substrate and the lower substrate which are plane members to space a window and the electrode pattern which are formed on the top of the upper substrate apart by a predetermined distance, thereby deteriorating touch sensitivity (due to a distance between the input unit that contacts the outer surface of the window and the electrode pattern).

### SUMMARY OF THE INVENTION

The present invention has been made in an effort to provide a capacitive touch screen that simplifies the structure by forming electrode patterns on both surfaces of one base member without forming the electrode pattern on each of an upper substrate and a lower substrate, has an inactive region and an active region which are spatially divided by configuring the outer part of the base member to be stepwise, and improves touch sensitivity by projecting the active region.

A capacitive touch screen according to a preferred embodiment of the present invention includes: a base member including an active region where an image generated in a display passes and an inactive region which extends from the active region and is formed to be stepwise; a plurality of electrode patterns which cross on the top and the bottom of the base member and are disposed in the active region; electrode wirings which are connected to the electrode patterns disposed in the active region and extend to the inactive region; and a window formed on the top of the base member.

Further, an interception film corresponding to the inactive region of the base member may be formed in the outer part of the bottom of the window.

The inactive region may be formed to be stepwise to surround the outer part of the active region.

The capacitive touch screen may further include a protection member formed on the bottom of the base member.

The electrode pattern may be made of a conductive polymer.

### BRIEF DESCRIPTION OF THE DRAWINGS

FIG. 1 is a perspective view showing a part of a capacitive touch screen according to a preferred embodiment of the present invention;

FIG. 2 is a top view of the capacitive touch screen shown in FIG. 1;

FIG. 3 is a rear view of the capacitive touch screen shown in FIG. 1;

FIG. 4 is a cross-sectional view of a capacitive touch screen according to a preferred embodiment of the present invention; and

FIGS. 5 and 6 are cross-sectional views showing a modified example of the capacitive touch screen shown in FIG. 4.

### DESCRIPTION OF THE PREFERRED EMBODIMENTS

Various objects, advantages and features of the invention will become apparent from the following description of embodiments with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, in describing the present invention, well-known functions or constructions will not be described in detail since they may unnecessarily obscure the understanding of the present invention.

Hereinafter, a preferred embodiment of the present invention will be described in detail with reference to the accompanying drawings.

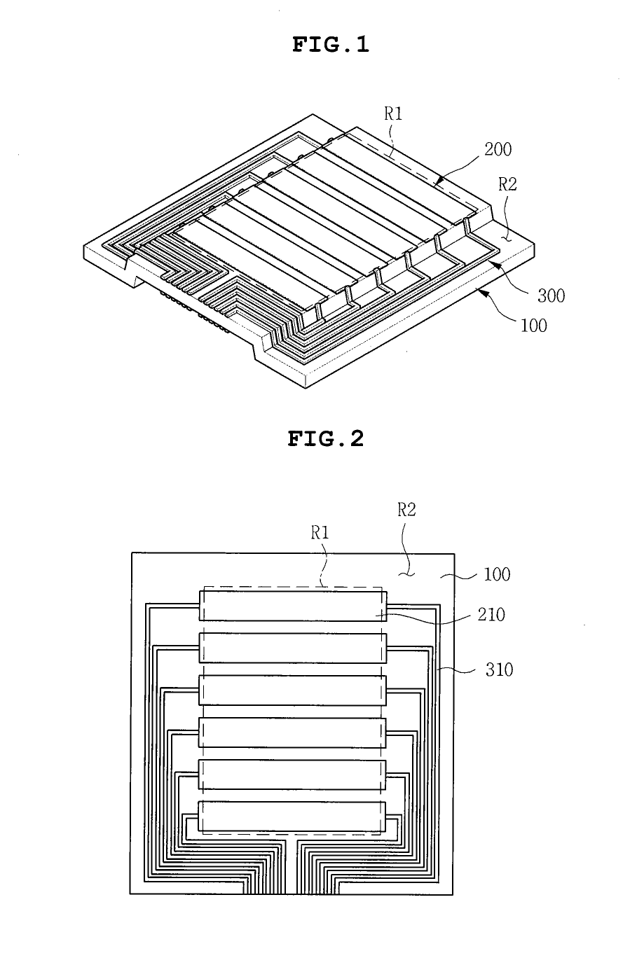

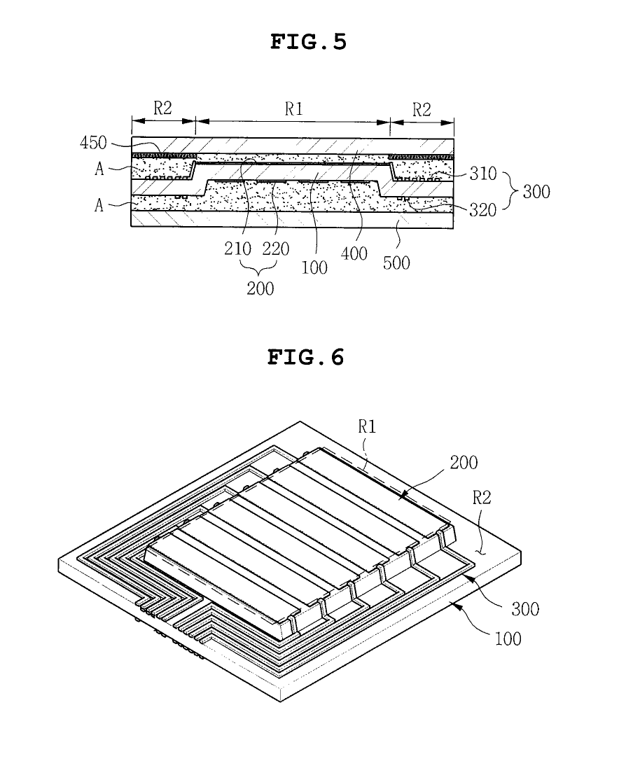

FIGS. 1 to 3 are a perspective view, a top view, and a rear view showing a part of a capacitive touch screen according to a preferred embodiment of the present invention. FIG. 4 is a cross-sectional view of a capacitive touch screen according to a preferred embodiment of the present invention. FIGS. 5 and 6 are cross-sectional views showing a modified example of the capacitive touch screen shown in FIG. 4. Hereinafter, the capacitive touch screen (hereinafter, referred to as a touch screen) according to the preferred embodiment of the present invention will be described.

In the touch screen according to the preferred embodiment of the present invention, an electrode pattern 200 and an electrode wiring 300 are formed on both surfaces of a base member 100 and an inactive region R2 extending from an active region R1 of the base member 100 is formed to be stepwise, such that a region through which an image passes and a region through which the image does not pass are spatially divided. The base member 100 may be formed by a method of forming a step in the inactive region R2 by pressing a plane member.

In addition, a window 400 is formed on the top of the base member 100 to protect an upper electrode pattern 210 and an upper electrode wiring 310 and form a touched surface which is touched by input unit. The window 400 may be coupled to the base member 100 by using an optical adhesive A such as an OCA.

According to the preferred embodiment of the present invention, the electrode pattern 200 is formed in the active region R1 to minimize a distance from the window 400, thereby improving touch sensitivity and the inactive region R2 is formed to be stepwise, thereby ensuring a space where the electrode wiring 300 will be formed.

The base substrate 100 as a transparent member may adopt a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylethylenenaphtalate (PEN), polycarbonate (PC), polyethersulfone (PES), polyimide (PI), polyvinylalcohol (PVA), cyclic olefin copolymer (COC), stylene polymer, polyethylene, polypropylene, etc., and is not particularly limited.

The electrode pattern 200 is formed in the active region R1 and the electrode wiring 300 is formed in the inactive region R2. Since the electrode pattern 200 and the electrode wiring 300 are formed on both surfaces of the base member 100, the structure may be simplified, a manufacturing cost may be saved, and a slim touch screen may be manufactured, unlike the touch screen in the prior art.

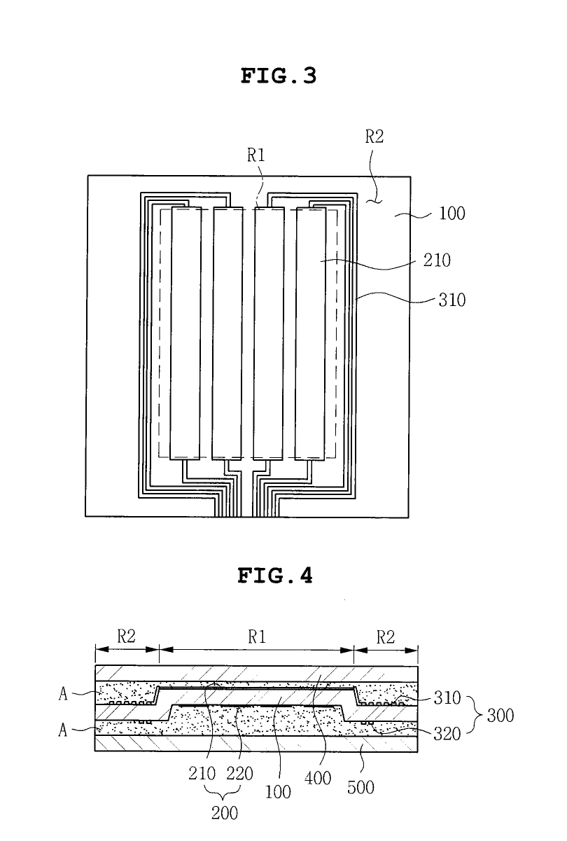

In this case, the plurality of electrode patterns are formed in the active region R1 of the base member 100 and the upper electrode pattern 210 and the lower electrode pattern 220 are intersected with each other. In particular, as shown in FIGS. 2 and 3, the upper electrode pattern 210 is preferably perpendicular to the lower electrode pattern 220. In FIGS. 2 and 3, a bar-type electrode pattern is shown, but the shape of the electrode pattern is not limited thereto and the electrode pattern may be formed in a type in which polygonal sensing units and connection units are repetitively disposed.

In the touch screen according to the preferred embodiment of the present invention, an X coordinate and a Y coordinate are measured and coordinate information on a touch point is acquired by measuring the variations of capacitances which occur in the upper electrode pattern 210 and the lower electrode pattern 220 when a user's finger touches the touch screen.

The electrode pattern 200 is made of a transparent conductive material. Metal oxide such as ITO may be adopted and a conductive polymer which may be manufactured at a low cost and in a mass is preferable. The conductive polymer may adopt polythiophene-based, polypyrrole-based, polyaniline-based, polyacetyl-based, polyphenylene-based, etc., as organic compounds. In particular, among the polythiophene-based compounds, a PEDOT/PSS compound is most preferable and one or more kinds of compounds among the organic compounds may be mixed and used. Further, when a carbon nanotube, etc., is additionally mixed, conductivity may be improved.

One end of the electrode wiring 300 is connected to the electrode pattern 200 and extends to the inactive region R2, such that the electrode wirings 300 are collected at one portion of the inactive region R2 for connection with an FPC. Therefore, the electrode wirings 300 are formed in proportion to the number of the electrode patterns 200. In FIGS. 1 to 5, the electrode wiring 300 is connected to both ends of the electrode pattern 200, but the electrode wiring 300 may be configured to be connected to only one end of the electrode pattern 200 in accordance with a control method to acquire the coordinate information on the touch point. This is already known and will not be described in detail.

The electrode wiring 300 may be made of the same material as the electrode pattern 200 or a paste having high conductivity. The electrode wiring 300 may be formed by a known method such as an inkjet method or a sputtering method.

In addition, it is preferable that a protection member 500 for covering the lower electrode pattern 220 and a lower electrode wiring 320 is further included in the bottom of the base member 100.

The touch screen may directly be attached to a display device without the protection member 500, but since the lower electrode pattern 220 and the lower electrode wiring 320 may be damaged while handling the touch screen, the protection member 500 is preferably formed. Further, since the protection member 500 provides a flat surface to the bottom of the touch screen, the touch screen may easily be coupled to the display device.

The protection member 500 may also be configured by a glass substrate or a film substrate and is coupled to the bottom of the base member 100 by the optical adhesive A such as the OCA.

At this time, in the touch screen according to the preferred embodiment of the present invention, a interception film 450 corresponding to the inactive region R2 of the base member is preferably in the outer part of the bottom of the window 400 as shown in FIG. 5.

In the case in which the electrode wiring 300 is made of a metallic material such as a silver paste, the electrode wiring 300 is exposed to the outside. In the prior art, a bezel structure to cover the electrode wiring by using a housing formed in the outer part of the touch screen is adopted in order to prevent the exposure. In the touch screen according to the preferred embodiment of the present invention, the electrode wiring 300 is prevented from being exposed to the outside by directly forming the interception film 450 on the window 400 without forming an additional bezel structure. In the prior art, the bezel structure is deformed or broken by external friction, but in the touch screen according to the preferred embodiment of the present invention, the interception film 450 is formed in the touch screen to solve the problem in the prior art.

Further, in the base member 100, the electrode wiring 300 is formed in the inactive region R2 corresponding to the outer part where the interception film 450 of the window 400 is formed. The inactive region R2 is formed to be stepwise to ensure the distance from the window 400. As a result, even though the electrode wiring 300 is formed slightly high, it is possible to prevent the interferences of the interception film 450 and the electrode wiring 300.

The interception film 450 may be formed by printing the outer part of the bottom of the window 400 with ink having low brightness such as black ink.

In addition, in a touch screen according to another preferred embodiment of the present invention, the inactive region R2 is preferably formed to be stepwise to surround the outer part of the first active region R1 as shown in FIG. 6.

That is, only the active region R1 is projected by forming the entire inactive regions of the base member 100 to be stepwise. In the touch screen shown in FIGS. 1 to 5, only two regions which are opposed to each other in the outer part of the base member 100 are formed to be stepwise, such that a part of the inactive region R2 is projected like the active region R1.

At this time, in the case in which the electrode wiring 300 is made of the same material as the electrode pattern 200 and the electrode wirings 300 are collected in the projected inactive region R2, noise may be generated due to the interference between the electrode wiring 300 and the input unit at the time of measuring the change in the capacitance in the electrode pattern 200 while the input unit is close to touch the inactive region R2. Further, when the electrode pattern is connected with the electrode wiring through the FPC, a portion to which the FPC is coupled may be projected.

As shown in FIG. 6, in the case in which the entire inactive region R2 is formed to be stepwise, the region at which the electrode wirings 300 are collected is also distant from the window 400, such that the interference between the electrode wiring 300 and the input unit decreases. Further, a space to which the FPC will be coupled is ensured.

According to a preferred embodiment of the present invention, since a touch screen can be manufactured by using one substrate by forming electrode patterns on both surfaces of a base member unlike the case of using two substrates in the touch screen in the prior art, the structure is simplified.

Further, an inactive region and an active region are spatially divided by configuring the outer part of the base member and the electrode pattern can be disposed very close to a window by forming an electrode wiring in the inactive region and the electrode pattern in the active region.

While the present invention has been shown and described in connection with the preferred embodiments, it will be apparent to those skilled in the art that modifications and variations can be made without departing from the spirit and scope of the invention. Accordingly, the modifications or variations are defined by the appended claims.

What is claimed is:

1. A capacitive touch screen, comprising:
a base member including an active region through which an image generated in a display passes and an inactive region which extends from the active region and is formed to be stepwise;
a plurality of electrode patterns which intersects with the top and the bottom of the base member and are disposed in the active region;
electrode wirings which are connected to the electrode patterns disposed in the active region and extend to the inactive region; and
a window formed on the top of the base member.

2. The capacitive touch screen as set forth claim 1, wherein an interception film corresponding to the inactive region of the base member is formed in the outer region of the bottom surface of the window.

3. The capacitive touch screen as set forth claim 1, further comprising a protection member formed on the bottom of the base member.

4. The capacitive touch screen as set forth claim 1, wherein the electrode pattern is made of a conductive polymer.

5. The capacitive touch screen as set forth claim 1, wherein the inactive region is formed to be stepwise to surround the outer part of the active region.
